(19) United States
(12) Patent Application Publication
(10) Pub. No.: US 2006/0108825 A1
(43) Pub. Date: May 25, 2006

(54) Vehicular messaging system

(76) Inventor: Malcolm Petty, Grandbury, TX (US)

Correspondence Address: Michael A. O'Neil;Michael A. O'Neil, P.C., Suite 820, 5949 Sherry Lane, Dallas, TX, 75225, US

(21) Appl. No.: 11/324,626

(22) Filed: Jan. 3, 2006

Related U.S. Application Data
(63) Continuation-in-part of application No. 11/181,434, filed on Jul. 14, 2005.
(60) Provisional application No. 60/588,267, filed on Jul. 15, 2004.

(51) Int. Cl. B60P 7/02

(52) U.S. Cl. 296/100.04

(57) ABSTRACT

An accessory for a pickup truck and the like comprising a frame that supports a plurality of louvers which are selectively positionable in various orientations. The louvers are adapted to display selected graphics when positioned in the first and third orientations. The frame may be positioned on most outer surfaces of a pickup truck or other vehicle.

### CROSS-REFERENCE TO RELATED APPLICATIONS

This application is a continuation-in-part application of application Ser. No. 11/181,434 filed Jul. 14, 2005, currently pending, the entire content of which is incorporated herein by reference; which claims priority of provisional Application Ser. No. 60/588,267 filed Jul. 15, 2004, the entire content of which is incorporated herein by reference.

### TECHNICAL FIELD

This invention relates generally to vehicular accessories and more particularly to an accessory for display of pickup trucks and the like which displays graphics such as advertising, artwork, etc.

### BACKGROUND AND SUMMARY OF THE INVENTION

The present invention comprises an accessory for pickup trucks and similar vehicles which facilitates the display of graphics and messages such as advertising, artwork, etc. In accordance with the broader aspects of the invention a plurality of louvers are formed from a mirrored semi-transparent material, for example, plastic sheet material. The louvers are pivotally supported on a frame and are arranged in an equally spaced, overlapping array. The louvers are selectively positionable relative to the vehicle upon which the accessory is installed.

In accordance with more specific aspects of the invention the louvers are positionable in any of three orientations. In the first orientation the louvers extend angularly downwardly and substantially parallel to the rear window of the vehicle thereby facilitating the display of a first message or graphic. In the second orientation the louvers extend perpendicularly to the rear window thereby facilitating maximum visibility therethrough. In the third orientation the louvers extend angularly upwardly and substantially parallel to the rear window thereby facilitating the display of a second message or graphic.

An alternative embodiment of the invention employs triangular louvers having three surfaces upon which information is displayed thereby facilitating additional display of advertising, graphics, and the like. The triangular louvers are more rigid than substantially flat louvers and thereby eliminate any catching of the louvers or chatter caused by overlap of the louvers.

### BRIEF DESCRIPTION OF THE DRAWINGS

A more complete understanding of the present invention may be had by reference to the following Detailed Description when taken in connection with the accompanying Drawings, wherein:

FIG. 1 is a perspective view of a pickup truck having the accessory of the present invention installed thereon;

FIG. 2A is an enlargement of a portion of FIG. 1 showing the louvers of the accessory in a first orientation;

FIG. 2B is a view similar to FIG. 2A showing the louvers of the accessory in a second orientation;

FIG. 2C is a view similar to FIG. 2A showing the louvers of the accessory in a third orientation;

FIG. 3 is a view similar to FIG. 2A illustrating a second embodiment of the invention;

FIG. 4 is an enlargement of a portion of FIG. 2A illustrating a first mechanism for manipulating the louvers of the accessory of the present invention;

FIG. 5 is an illustration similar to FIG. 4 showing a second mechanism for manipulating the louvers of the accessory of the present invention;

FIG. 6A is an illustration similar to FIG. 2A showing the accessory of the present invention installed on a pickup bed cover and illustrating the louvers of the accessory in a first orientation;

FIG. 6B is a view similar to FIG. 6A illustrating the louvers of the accessory in a second orientation;

FIG. 6C is a view similar to FIG. 6A showing the louvers of the accessory in a third orientation;

FIG. 7 is a view similar to FIG. 4 showing the accessory of the present invention employing triangular louvers;

FIG. 8 is a view similar to FIG. 1 showing the accessory of the present invention installed on a tailgate of a pickup truck;

FIG. 9 is an enlarged view of a mechanism for manipulating the louvers of the accessory of the present invention employing triangular louvers;

FIGS. 10A, 10B, and 10C are enlarged views of Geneva mechanism useful in the practice of the invention;

FIG. 11 is a perspective view of a car having the accessory of the invention in a third embodiment;

FIG. 12 is a perspective view of a car having the accessory of the invention in a fourth embodiment;

FIG. 13 is a view similar to FIG. 8 showing the accessory of the invention installed over the tailgate of a pickup truck; and

FIG. 14 is a an exploded view showing the accessory of the invention with means for securing same on various surfaces of a vehicle.

### DETAILED DESCRIPTION

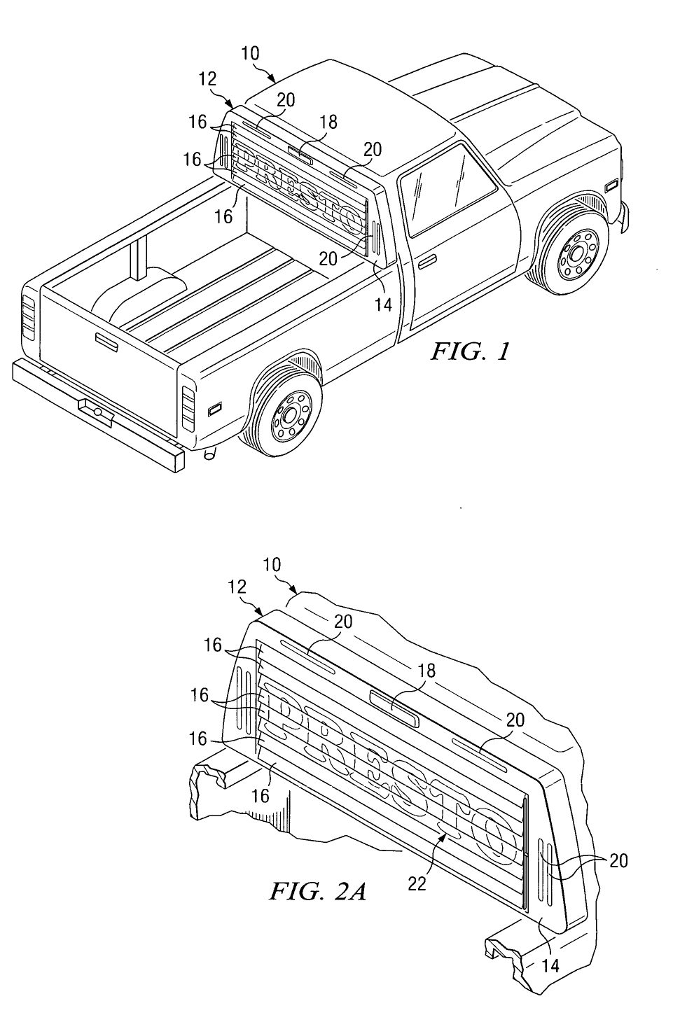

Referring now to the drawings and particularly to FIG. 1 thereof, there is shown a pickup truck 10 having an accessory 12 comprising the present invention installed thereon. Although a particular type of pickup truck is illustrated in the drawings, it will be understood that the invention is equally applicable to a wide variety of types and kinds of pickup trucks and similar vehicles.

The accessory 12 comprises a frame 14 which may be manufactured from a wide variety of materials including steel, aluminum, and other metals; polyethylene, polystyrene, polyvinylchloride, and other plastics; and other materials including wood. The frame 14 is secured to the cab and/or to the walls of the bed of the pickup truck 10 and is generally vertically oriented. A plurality of louvers 16 are mounted on the frame 14 for pivotal movement with respect thereto. As will become more apparent hereinafter, the louvers 16 are selectively positionable in any of the three orientations relative to the frame 14 of the accessory 12. The frame 14 may also be provided with a lamp 18 for illuminating the bed of the pickup truck 10, running lights 20, and other features.

The louvers 16 of the accessory 12 of the present invention are preferably mirrored, i.e., provided with reflective exterior surface on at least one side thereof. In this manner the prevention of glare and heat from the sun from entering the interior of the cab of the pickup truck is maximized. Notwithstanding the reflective exterior surface thereof the louvers 16 are constructed to be as transparent as possible thereby facilitating the ability of the driver of the pickup truck to see through the rear window thereof. The louver 16 may be manufactured from the plastic material sold by General Electric under the trademark “LEXAN”®. Other plastic materials may be utilized in the manufacture of the louvers 16 depending upon the requirements of particular applications of the invention.

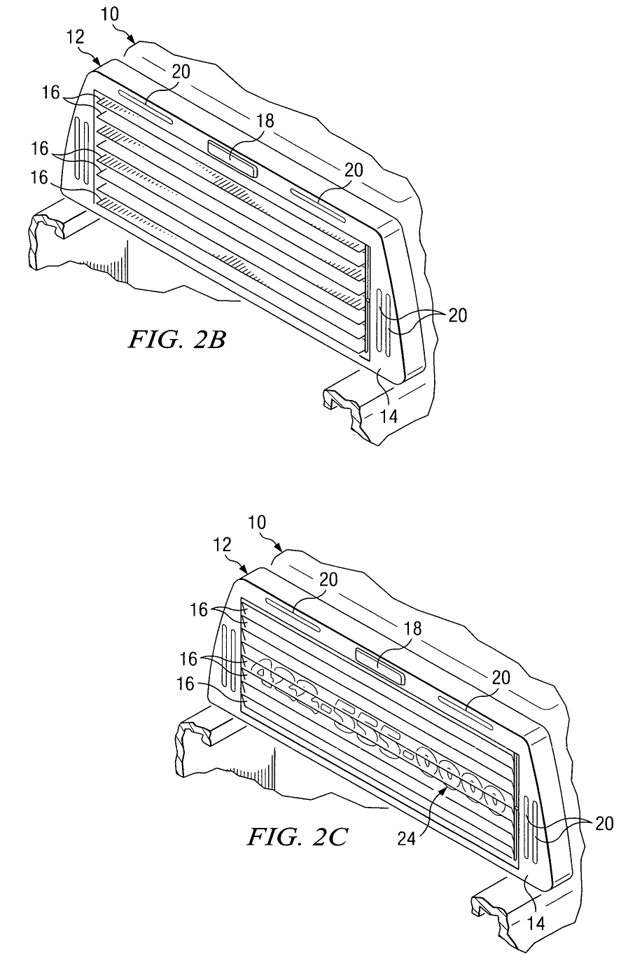

FIG. 2A illustrates the louvers 16 of the accessory 12 in a first orientation. In the first orientation the louvers 16 extend angularly downwardly and substantially parallel to the rear window of the pickup truck 10. Positioning of the louvers 16 in the first orientation facilitates the display of a first graphic or message 22 thereon. The first graphic 22 may comprise an advertisement, artwork, a selected message, etc. The graphic 22 is preferably fabricated in such a way that it does not significantly reduce visibility through the rear window of the pickup truck 10.

FIG. 2B illustrates the louvers 16 of the accessory 12 in a second orientation. In the second orientation the louvers 16 extend perpendicularly to the rear window of the pickup truck 10. When the louvers 16 are in the second orientation as illustrated in FIG. 2B maximum visibility through the rear window of the pickup truck 10 is afforded.

FIG. 2C illustrates the louvers 16 of the accessory 12 in a third orientation. In the third orientation the louvers 16 extend angularly upwardly and substantially parallel to the rear window of the pickup truck 10. Positioning of the louvers 16 in the third orientation facilitates the display of a second graphic or message 24 thereon. Like the graphic 22 the graphic 24 is preferably fabricated in such as a way as to not significantly reduce visibility through the rear window of the pickup truck 10.

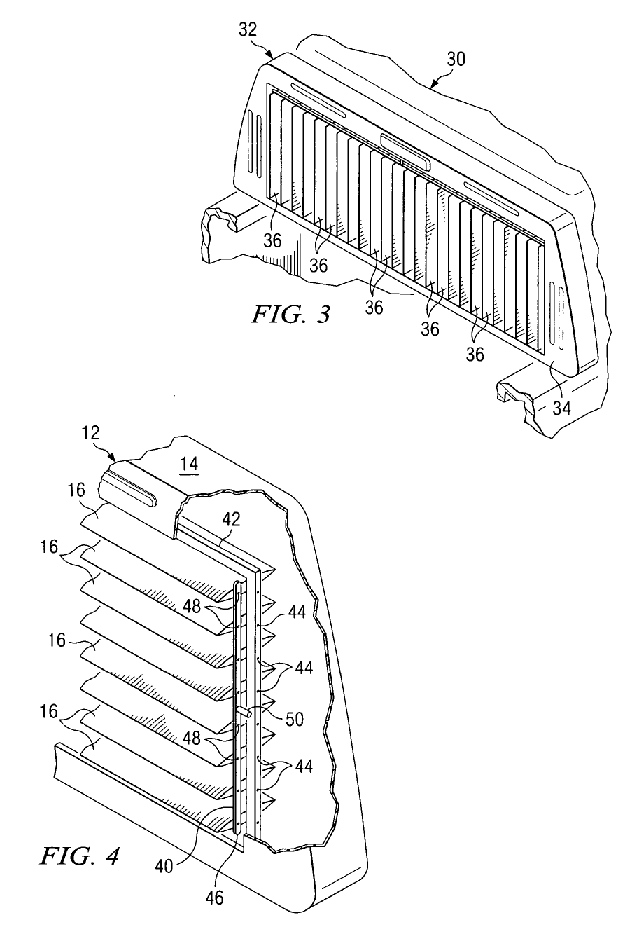

FIG. 3 illustrates a pickup truck 30 equipped with an accessory 32 comprising a second embodiment of the invention. The accessory 32 includes a frame 34 having a plurality of louvers 36 pivotally supported thereon. As opposed to the louvers 16 of the accessory 12 which are horizontally disposed, the louvers 36 of the accessory 32 are vertically disposed. Otherwise the accessory 10 is structurally and functionally identical to the accessory 12 as described hereinabove in conjunction with FIGS. 1, 2A, 2B, and 2C.

FIG. 4 illustrates a first mechanism 40 manipulating the louvers 16 of the accessory 12 between the first, second, and third orientations as illustrated in FIGS. 2A, 2B, and 2C. The louvers 16 are pivotally supported on a subframe 42 by a plurality of pins or rods 44. An actuating rod 46 is pivotally connected to the louvers 16 by a plurality of pins or rods 48. A handle 50 is positioned for convenient actuation by a person situated at one side of the pickup truck 10 and behind the rear window thereof. Actuation of the handle 50 moves the rod 46 vertically thereby manipulating the louver 16 between the first, second, and third orientations as illustrated in FIGS. 2A, 2B, and 2C. The frame 14 may be provided with an access port or a notch to facilitate actuation of the handle 50.

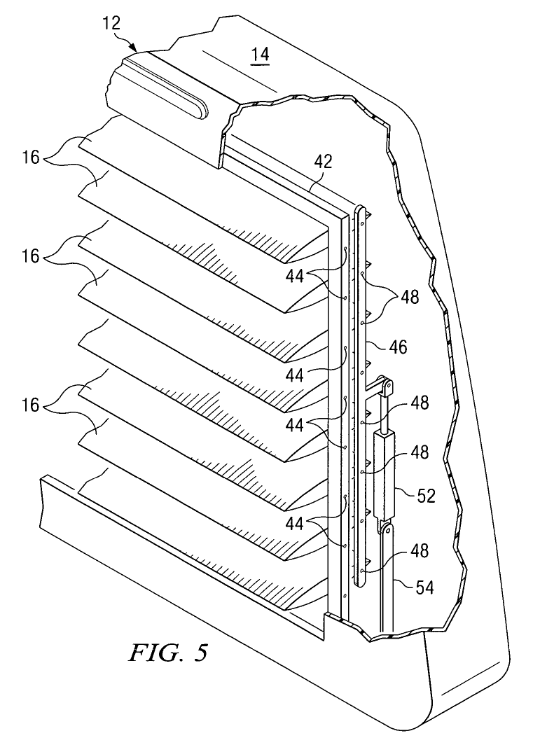

FIG. 5 illustrates an automated mechanism 52 for manipulating the louvers 16 of the accessory 12 between the first, second, and third orientations as illustrated in FIGS. 2A, 2B, and 2C. Many of the component parts of the mechanism 52 are identical to construction and function to component parts of the mechanism 40 as illustrated in FIG. 4 and described hereinabove in conjunction therewith. Such identical component parts are designated in FIG. 5 with the same reference numerals utilized in the foregoing description of the mechanism 40.

As opposed to the handle 50 of the mechanism 40 of FIG. 4, the mechanism 52 of FIG. 5 includes an actuator which is connected between the rod 46 and the frame 14 by a bracket 54. The mechanism 52 may comprise a three position electrical solenoid, a three position fluid powered cylinder, or any other type of three position actuator. The mechanism 52 is adapted for actuation by the driver of the pickup truck 10 from within the cab thereof thereby facilitating the manipulation of the louvers 16 between the first, second, and third orientations thereof without leaving the cab of the pickup truck 10.

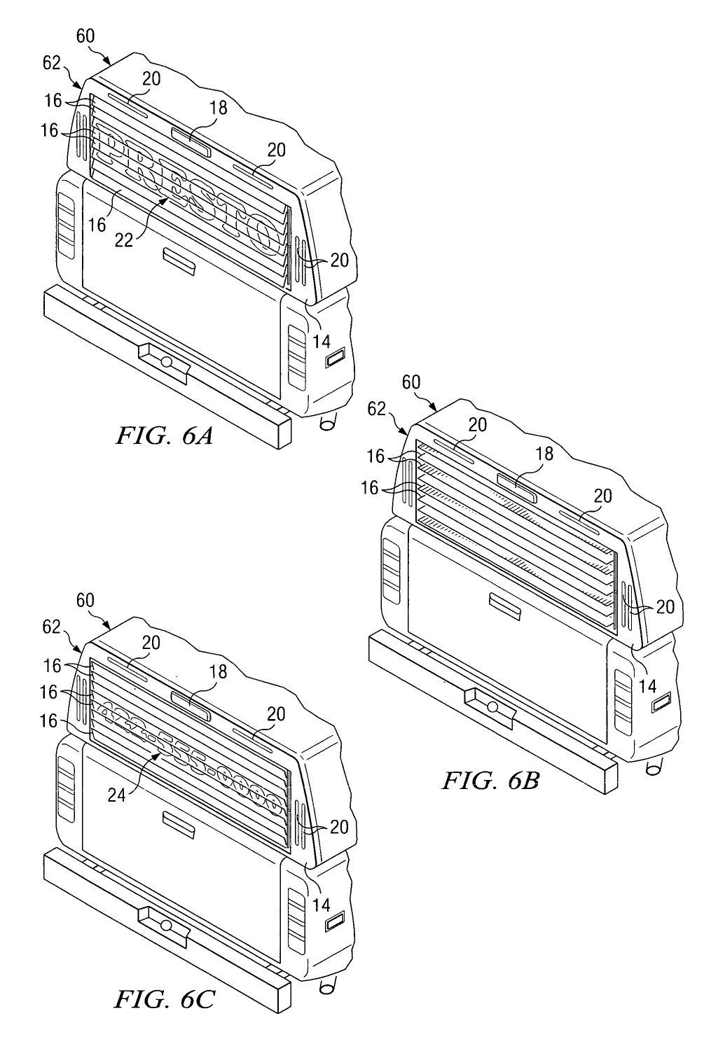

FIGS. 6A, 6B and 6C illustrate a pickup bed cover 60 having an accessory 62 comprising the present invention installed therein. Many of the component parts of the accessory 62 are substantially identical in construction and function to component parts of the accessory 12 as illustrated in FIGS. 1, 2A, 2B, and 2C and described hereinabove in conjunction therewith. Such identical component parts are designated in FIGS. 6A, 6B, and 6C with the same reference numerals utilized hereinabove in the description of the accessory 12. Other than the fact that it is installed in the pickup bed cover 60, the accessory 62 is structurally and functionally identical to the accessory 12.

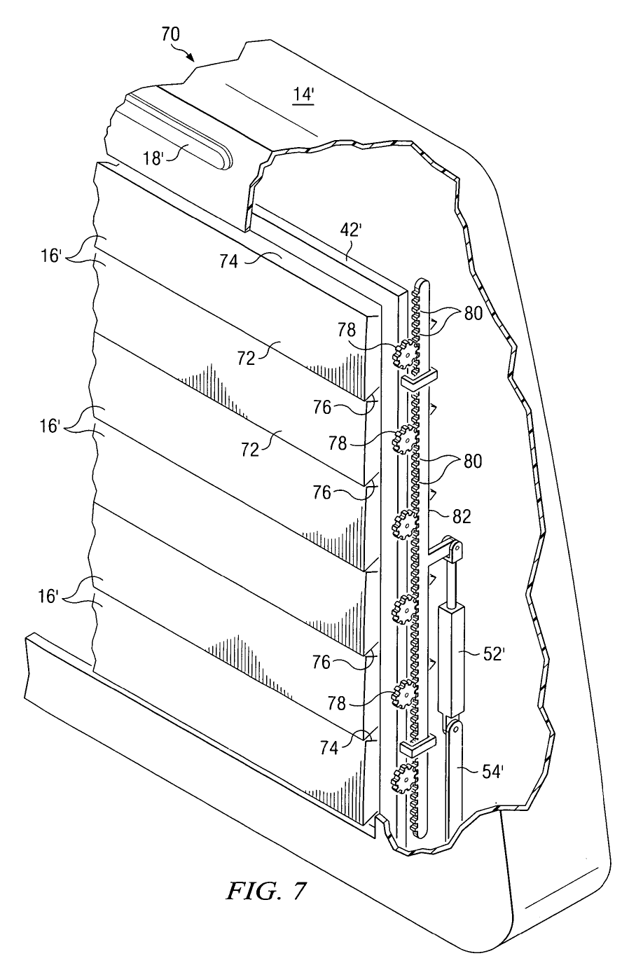

FIG. 7 illustrates the pickup truck 10 having an accessory 70 comprising the present invention installed thereon. Many of the component parts of the accessory 70 are substantially identical in construction and function to component parts of the accessory 12 as illustrated in FIGS. 1 through 6 and described hereinabove in conjunction therewith. Such identical component parts are designated in FIG. 7 with the same reference numerals utilized above in the description of the accessory 12, but are differentiated therefrom by means of a prime (′) designation.

The accessory 70 differs from the accessory 12 of FIGS. 1 through 6 in that the accessory 70 employs louvers 16′ having a triangular shape. The triangular louvers 16′ are selectively positionable in at least three orientations relative to the frame 14′. A first orientation of the louvers 16′ places a first surface 72 of the louvers 16′ in an orientation substantially parallel to rear window of the truck 10 thereby facilitating the display of a first message or graphic. Similarly, a second orientation of the louvers 16′ places a second surface 74 of each louver 16′ in an orientation substantially parallel to the rear window of the truck 10 thereby facilitating the display of a second message or graphic. Similarly, a third orientation of the louvers 16′ places a third surface 76 of each louver in an orientation substantially parallel to rear window of the truck 10 thereby facilitating the display of a third message or graphic.

The louvers 16′ are pivotally supported on a subframe and are each 42′ operatively connected to a pinion 78. The pinions 78 are secured in moveable mating engagement the with the teeth 80 of a rack 82. An automated mechanism 52′ having an actuator connected between the rack 82 and the frame 14′ by a bracket 54′ provides means for a driver of the truck 10 to actuate and manipulate the louvers 16′ between the first, second, and third orientations.

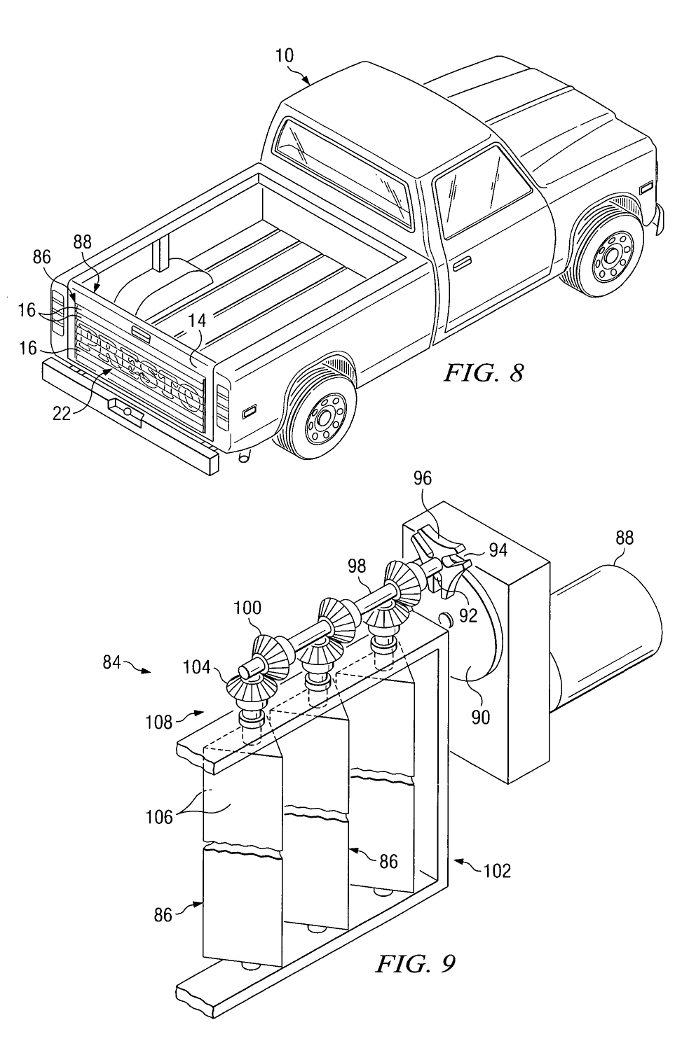

FIG. 8 illustrates the pickup truck 10 having an accessory 86 comprising yet another embodiment of the present invention installed on a tailgate 88 thereof. Many of the component parts of the accessory 86 are substantially identical in construction and function to component parts of the accessory 12 as illustrated in FIGS. 1 through 6 and described hereinabove in conjunction therewith. Such identical component parts are designated in FIG. 8 with the same reference numerals utilized hereinabove in the description of the accessory 12. Other than the fact that it is installed on the tailgate 88 of the pickup 10, the accessory 86 is structurally and functionally identical to the accessory 12.

FIG. 9 illustrates a mechanism 84 for manipulating louvers 86 having a triangular shape that are employed within an accessory 102. The louvers 86 are shown positioned vertically in FIG. 9, and the mechanism 84 is positioned to manipulate the louvers 86 about vertical axes, but it is understood that the louvers 86 could be positioned horizontally and the mechanism 84 positioned to manipulate the louvers 86 about horizontal axes as well.

An actuator 88 drives a Geneva mechanism comprising a cam 90 having a pin 92 that selectively engages slots 94 within a gear 96. The gear 96 comprises three slots 94 that receive the pin 92. The cam 90 is sized such that upon each 360 degree revolution of the cam 90 the pin 92 is received within one of the slots 94 of the gear 96, wherein the pin 92 turns the Geneva gear 96 120 degrees. The cam 90 and the gear 96 revolve in the same plane, but in opposite directions. The cam 90 must revolve three times in order to cause the gear 96 to revolve once.

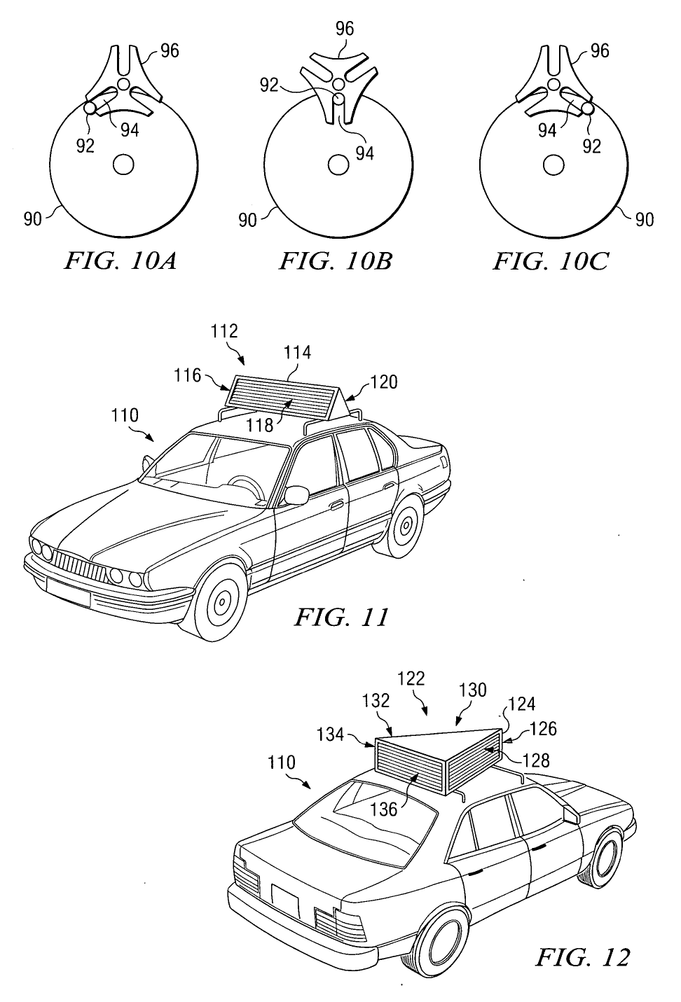

FIGS. 10A, 10B, and 10C show the pin 92 received within the slot 94 of the gear 96 and the movement of the slot 94 120 degrees. The cam 90 is shown turning clockwise and causing the gear 96 to turn counter-clockwise.

Referring again to FIG. 9, the gear 96 is connected to and turns an actuating rod 98. The actuating rod 98 comprises a plurality of pinions 100. The pinions 100 are secured in moveable mating engagement with gears 104 that are connected to the louvers 86 having three surfaces 106. The louvers 86 are selectively positionable in at least three orientations, wherein each 120 degree turn of the gear 96 causes one of the surfaces to be viewable from the side 108 of the accessory 102.

In FIG. 11 there is shown a third embodiment of the invention. A vehicle 110 has an accessory 112 comprising a frame 114 having a front surface 116 supporting a first plurality of louvers 118 and a rear surface supporting a second plurality of louvers 120. Both the first plurality of louvers 118 and the second plurality of louvers 120 are supported and manipulated as previously explained in FIG. 9.

In FIG. 12 there is shown a fourth embodiment wherein the vehicle 110 has an accessory 122 comprising a frame 124 having a first surface 126 supporting a first plurality of louvers 128, a second surface 130 supporting a second plurality of louvers 132, and a third surface 134 supporting a third plurality of louvers 136. As in FIG. 11, the three pluralities of louvers are supported and manipulated as previously described.

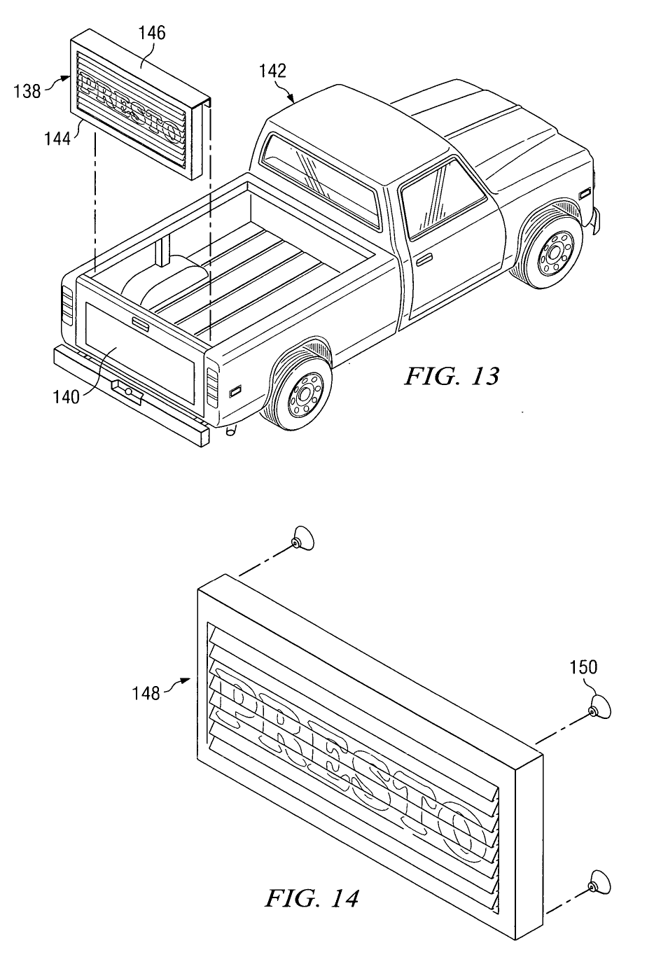

In FIG. 13 there is shown an accessory 138 installed over the tailgate 140 of a pickup truck 142. Many of the component parts of the accessory 138 are substantially identical in construction and function to component parts of the accessory 86 in FIG. 8. However, the accessory 138 comprises a frame 144 having a lip 146 that is used to install the accessory 138 over the tailgate 140 of a pickup truck 142. Thus, the accessory 138 is easily removable from the tailgate of the pickup truck 142.

In FIG. 14 there is shown an accessory 148 that may be easily attached to and removed from a surface of a vehicle through the use of securing devices 150. The device 150 may be suction devices as shown in FIG. 14, or any similar devices that allows the accessory 148 to be easily attached to and removed from substantially flat surfaces of vehicles. The component parts of the accessory 148 are substantially identical in construction and function to component parts of the accessory 86 in FIG. 8.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

1. An accessory for a vehicle comprising:
a first plurality of triangular louvers each having first, second, and third outer surfaces;
a second plurality of triangular louvers each having first, second, and third outer surfaces;
a frame for supporting the louvers on a roof of the vehicle;
means for supporting the louvers for pivotal movement relative to the frame; and
means for selectively pivoting the louvers relative to the frame between a first orientation wherein the first outer surface of the louvers is positioned substantially parallel to the frame, a second position wherein the second outer surface of the louvers is positioned substantially parallel to the frame, and a third orientation wherein the third outer surface of the louvers is positioned substantially parallel to the frame.

2. The accessory according to claim 1 further comprising a third plurality of louvers.

3. An accessory for a vehicle comprising:
a plurality of triangular louvers each having first, second, and third outer surfaces;
a frame for supporting the louvers adjacent to a tailgate of the vehicle;
the frame comprising a lip for hanging the accessory over a top edge of the tailgate of the vehicle;
means for supporting the louvers for pivotal movement relative to the frame; and
means for selectively pivoting the louvers relative to the frame between a first orientation wherein the first outer surface of the louvers is positioned substantially parallel with the tailgate of the vehicle, a second orientation wherein the second outer surface of the louver is positioned substantially parallel with the tailgate of the vehicle, and a third orientation wherein the third outer surface of the louvers is positioned substantially parallel with the tailgate of the vehicle.

4. An accessory for a vehicle comprising:
a plurality of triangular louvers each having first, second, and third outer surfaces;
a frame for supporting the louvers adjacent to an outer surface of the vehicle;
means for attaching the frame to the outer surface of the vehicle;
means for supporting the louvers for pivotal movement relative to the frame; and
means for selectively pivoting the louvers relative to the frame between a first orientation wherein the first outer surface of the louvers is positioned substantially parallel with the outer surface of the vehicle, a second orientation wherein the second outer surface of the louver is positioned substantially parallel with the outer surface of the vehicle, and a third orientation wherein the third outer surface of the louvers is positioned substantially parallel with the outer surface of the vehicle.
